(19) United States
(12) Patent Application Publication
(10) Pub. No.: US 2005/0237530 A1
(43) Pub. Date: Oct. 27, 2005

(54) Imaging apparatus for small spot optical characterization

(76) Inventor: Mark Victor Schnittker, San Jose, CA (US)

Correspondence Address: Mark Schnittker, 1026 - 1/2 Lowst Street, San Jose, CA, 95110, US

(21) Appl. No.: 10/832,792

(22) Filed: Apr. 26, 2004

(51) Int. Cl. G01N 21/55

(52) U.S. Cl. 356/445

(57) ABSTRACT

An imaging tool which has an objective lens, a beam splitting mirror and a turning mirror. The turning mirror has a centrally integrated aperture. The turning mirror is located at a secondary focal plane in the illumination path, and thus there is no illumination at any point on the object pane which is stigmatic with the integrated aperture. The integrated aperture provides a means to inject or remove light from a small spatial portion of the object plane. An airspace waveguide is integrated into the metal substrate of the turning mirror and eases the transfer of light from an external optical port to and from the aperture, and then onto the object plane.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of microscopy and more specifically to small spot optical characterization.

Optical characterization of materials has long been a valuable tool across many fields. Non-contact thermometry, electroluminescense, fluorescence, reflectance, and transmittance are some common forms of optical characterization. These techniques are greatly diverse in geometry, optical materials and wavelength, but they share a common trend. As technologies shrink in their physical dimensions, there exists a need to make the same measurement in a smaller area. As the measurement area reduces, the challenge of optical characterization becomes more difficult. This trend is very noticeable in the semiconductor industries where the scales are microscopic. Simple, non-contact, non-destructive optical techniques are heavily relied upon in the testing and failure analysis of semiconductors. When implemented in a manufacturing process, the optical tools must be simple, robust, easy to use and small enough to retrofit into existing equipment. When optical techniques are used in failure analysis, they must be flexible enough to handle different wavelengths and configurable for multiple detectors.

Small area optical characterization is generally done using either an imaging or non-imaging system.

Imaging systems are typically a microscope, which send a portion or all of the gathered light to a detector or a 2D focal plane array. The primary function of these tools is correlated to the spectral band pass characteristics of their optics and detector. FTIR, thermal imaging, and laser scanning are examples of specialized imaging systems for optical characterization.

Non-imaging systems typically use a collimated fiber or a small detector with a lens mounted orthogonal and close to the surface of the sample. The detector is generally mounted with some type of motorized automation, and the position is mapped using the known distance from an index point which is often the flat of a wafer. Non-imaging systems rely on the fixture to know their position and focus.

Imaging microscopes for optical characterization are highly specialized optical tools, which require more space and support than a standard microscope. The complexity of their design increases cost beyond what is justified for simple optical characterization in semiconductor processes. Furthermore, their physical size is generally too large to mount into existing equipment where space is of concern. Infrared versions of these microscopes that use thermal or near infrared 2D imagers also suffer from reduced resolution due to the low pixel density of current technologies. The combination of size and cost yield complex microscope designs impractical to implement on a large scale.

Non-imaging optical assemblies designed for optical characterization are small, simple and low cost but make it difficult to target the optical system onto a small well defined position. Supplementing the system with a microscope mounted at an angle relative to the assembly can reduce this issue, but suffers from parallax in systems that do not project a beam of light onto the surface of the sample. Furthermore, non-imaging systems have no feedback to the user of their focus. Because of the focus and alignment uncertainty, the chances of obtaining poor data are increased. Many of the non-imaging configurations also have very short working distances, which prohibit their use in applications that have obstructions. The increased challenge of robustly aligning non-imaging optical systems make them a poor choice for both production and failure analysis applications in the semiconductor industry.

### BRIEF SUMMARY OF THE INVENTION

The primary object of the invention is to provide a simple low cost means of optical characterization on the micrometer scale.

Another object of the invention is to integrate a real time optical imager to ease the alignment of micrometer scale optical characterization.

A further object of the invention is to be able to perform such optical characterization over a large spectral range.

Yet another object of the invention is to use a compact form small enough to me mounted into other equipment.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an imaging apparatus for small spot optical characterization comprising: an optical housing, a beam splitter, and a turn mirror assembly. Said optical housing provides a focal plane and an image plane confocal to each other. Said turn mirror assembly integrates a reflective surface, aperture, airspace waveguide, and an optical port. The aperture integrated into the turn mirror assembly greatly simplifies the design while illumination incident on the aperture provides a projection of the optical port onto the surface of the object. The projected image of the optical port onto the object creates a dark target, which is viewable at the image plane using a low cost CCD camera. The field of view of the CCD camera is large compared to that of the optical port, but is spectrally narrow. The large field of view allows for real time alignment of the projected optical port onto the sample. The aperture is located at the focal plane. The aperture and optical port are joined with the airspace waveguide. Because of the aperture, the optical port has a narrow field of view compared to that of the CCD image. Because the optical path from the objective lens to the optical port is entirely reflective, the optical port has functionality over a wide spectral range.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an optical schematic diagram illustrating the operation of the invention.

FIG. 2 is a cross sectional view of the optical housing.

FIG. 3 is a cross sectional view of the turn mirror assembly along the line A-A.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

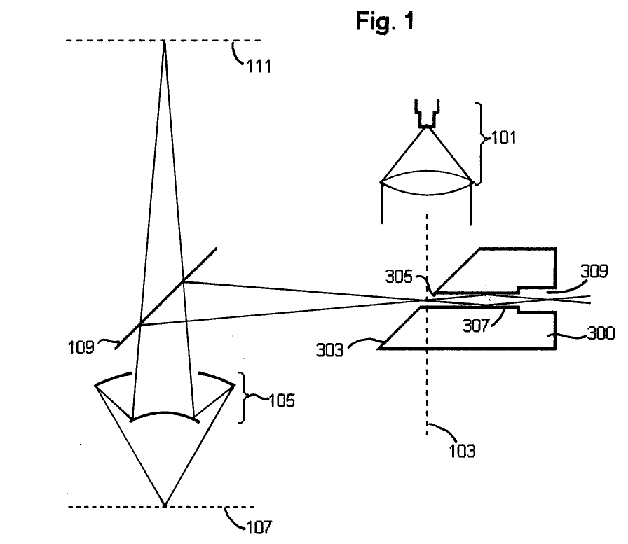

FIG. 1 is a schematic diagram of an imaging apparatus for small spot optical characterization in accordance with the present invention. The apparatus has accommodations for illumination from a near collimated light source 101. The light from the light source 101 illuminates the reflective surface 303 of the turn mirror assembly 300. The center of the reflective surface 303 is located at the focal plane 103. Light incident on the reflective surface 303 is reflected and turned in all areas except that of the location of the aperture 305. The reflected light is turned towards the beam splitter 109. A portion of the light incident on the beam splitter 109 is reflected and turned down to the objective optic 105, which is preferably of the reflective type for large spectral transmission. The objective optic 105 then images the light on to the object plane 107. The projection of the aperture 305 onto the object plane 107 leaves a dark area of the same shape as the aperture 305 and of a size which is the physical size of the aperture 305 divided by the power of the objective optic 105 for a given focal length. The optical port 309 is directly connected to the air space waveguide 307, which is then connected directly to the aperture 305, and thus the projection of the aperture 305 represents the projection of the optical port 309. Any light introduced at the optical port 309 will be internally reflected down the air space waveguide 307, through the aperture 305 and illuminate the projected image of the aperture 305 at the object plane 107. Light emitted or reflected from object plane 107, will be captured by the objective lens 105. Some of that light will pass the beam splitter 109 and be imaged at the image plane 111. The image created at the image plane 111 is only of the spectrum, which is passed by the beam splitter 109. The preferred imager is a CCD camera to provide a continuous video image of the object plane 107. The light, which is reflected and turned at the beam splitter 109 from the object plane 107, will be focused at the focal plane 103. The light focused onto the aperture 305 will pass into the airspace waveguide 307 and out the optical port 309.

The schematic representation of FIG. 1 illustrates the optical structure of an imaging apparatus for small spot optical characterization. The remainder of this disclosure shall be described in the context of single piece optical housing with cylindrical optical mounts as described below, but it is to be understood that the invention is not limited to this configuration.

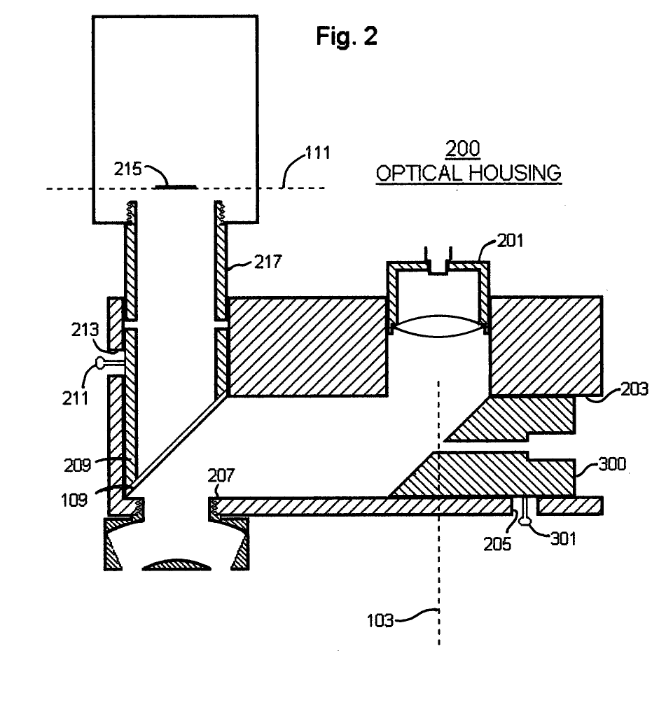

FIG. 2 is a cross sectional view of one embodiment of a microscope following the schematic representation of FIG. 1 and maintaining a simplistic approach. The optical housing 200 provides two optical paths; one for the image plane 111, and one for the focal plane 103. The optical housing 200 is a solid block of material with cylindrical ports. The cylindrical ports provide internal light paths and an optical port access 203 as well as means of attachment for the objective optic mount 207, for the camera mount tube 217, and for the illuminator mount 201. The camera mount tube 217 provides a means of mounting a CCD imager 215 at the image plane 111. The beam splitter 109 is mounted onto a cylindrical tube mount 209 cut at a 45-degree angle and is concentric with the optical housing 200 ports. The beam splitter adjusting lever 211 passes through the beam splitter adjusting lever port 213. The adjusting lever 211 allows for vertical and rotational control of the cylindrical tube mount 209. When the beam splitter cylindrical mount 209 is properly positioned, it can be set with a setscrew or adhesive. The turn mirror assembly 300 can be mounted in the same fashion as the beam splitter cylindrical mount 209 by using the turn mirror adjusting lever 301 protruding through the turn mirror adjusting lever port 205. The simplistic mounting technique is low cost yet allows for all degrees of freedom necessary to the alignment of the imaging apparatus.

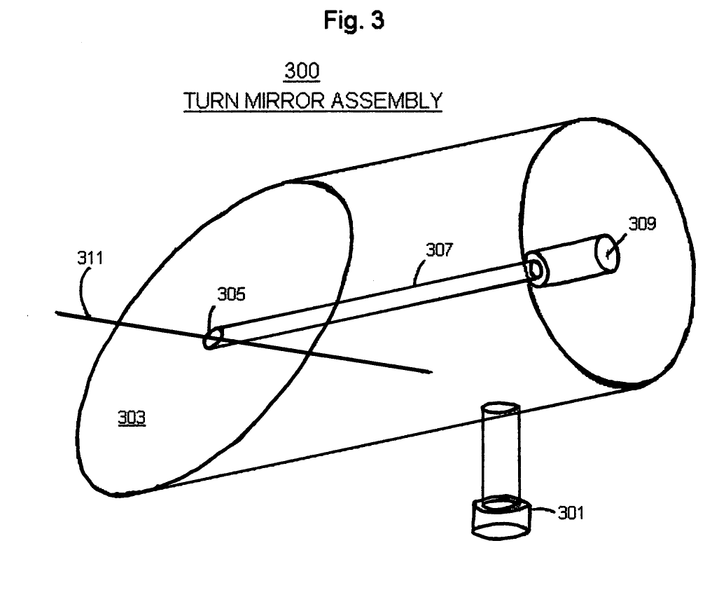

FIG. 3 is a cross sectional view of one embodiment of a turn mirror assembly 300 which can be used in the optical housing 200 of FIG. 2. In one embodiment, the turn mirror assembly 300 is manufactured out or a solid cylinder of material. The reflective surface 303 is polished from a face cut at 45 degrees relative to the radial axis of the cylinder of material. The aperture 305 is centered with the radial axis of the turn mirror assembly 300. The air space waveguide 307 is also centered along the radial axis of the turn mirror assembly 300 and is integral with the aperture 305. The inside surface of the airspace waveguide 307 is polished to reduce loss. An optical port 309 is centered with the airspace waveguide 307. An adjusting lever 301 is threaded into the turn mirror assembly 300 to allow for positioning of the turn mirror assembly 300 when installed in the optical housing 200. Any light incident on the reflective surface 303 will be turned in an upward direction. Any light incident on the aperture 305 will then be guided down the airspace waveguide 307 and out the optical port 309. Likewise, and light injected into the optical port 309 will be guided down the airspace waveguide 307 and out the aperture 305. Thus a projection of the aperture 305 is also a projection of the optical port 309.

In another embodiment, the aperture 305 is not located at the center of the turn mirror assembly's 300 radial diameter, but instead at any point on the coincidence line 311. The coincidence line 311 is the intersection of the focal plane 103 shown in FIGS. 1 and 2, and the turn mirror assembly's reflective surface 303 when the turn mirror assembly 300 is properly aligned in the optical housing 200. The airspace waveguide 307 and optical port 309 are then translated along the coincidence line 311 with the position of the aperture 305. With the turn mirror assembly 300 properly aligned, any point on the coincidence line 311 will be projected on to the object plane when the image at the image plane 111 is in focus. For this reason multiple optical ports can be projected on the object plane 107 of FIG. 1 simultaneously.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. An imaging apparatus for small spot optical characterization comprising:
An optical housing;
A beam splitter; and
A turn mirror assembly.

2. The apparatus as claimed in claim 1 wherein said optical housing provides an image plane and a focal place confocal to each other.

3. The apparatus as claimed in claim 2 further comprising of a means to attach a camera or ocular at said image plane of said optical housing.

4. The apparatus as claimed in claim 1 further comprising of a means to attach an optical objective to said optical housing.

5. The apparatus as claimed in claim 1 further comprising of a means to access the rear portion of said turn mirror assembly from said optical housing.

6. The apparatus as claimed in claim 1 further comprising of a means to attach an illuminator to said optical housing.

7. The apparatus as claimed in claim 1 further comprising of a means to mount and adjust optical components within the said optical housing.

8. The apparatus as claimed in claim 1 wherein said beam splitter is of a broadband metallic type.

9. The apparatus as claimed in claim 1 wherein said turn mirror assembly comprises:
An adjusting lever;
An angle cut reflective surface;
An aperture in said reflective surface;
An airspace waveguide; and
An optical port.

10. The apparatus as claimed in claim 9 wherein said airspace waveguide connects directly to said aperture.

11. The apparatus as claimed in claim 9 wherein said airspace waveguide connects directly to said optical port.
